(19) United States
(12) Patent Application Publication
(10) Pub. No.: US 2026/0270618 A1
(43) Pub. Date: Sep. 10, 2026

(54) ELECTRONIC DEVICE FOR PROVIDING AUDIO SERVICE, AND OPERATING METHOD THEREOF

(71) Applicant: Samsung Electronics Co., Ltd., Suwon-si (KR)

(72) Inventors: Sanghoon LEE, Suwon-si (KR); Mijin JEONG, Suwon-si (KR); Seung HEO, Suwon-si (KR); Hangil MOON, Suwon-si (KR); Jaeha PARK, Suwon-si (KR); Kyoungho BANG, Suwon-si (KR)

(21) Appl. No.: 19/661,332

(22) Filed: Apr. 28, 2026

Related U.S. Application Data
(63) Continuation of application No. PCT/KR2024/015198, filed on Oct. 7, 2024.

(30) Foreign Application Priority Data
Nov. 7, 2023 (KR) 10-2023-0152377
Dec. 4, 2023 (KR) 10-2023-0173490

(51) Int. Cl. H04R 3/12; H04R 3/04; H04S 7/00

(52) U.S. Cl. CPC H04R 3/12; H04R 3/04; H04S 7/306; H04R 2420/07; H04R 2499/11; H04R 2499/15

(57) ABSTRACT

An electronic device includes: a communication circuit ; at least one processor; and memory including instructions which, when executed by the processor, may cause the electronic device to: receive a signal of a first channel from a first external electronic device and receive a signal of a second channel from a second external electronic device ; identify that a packet loss has occurred in the first channel; identify whether inter-channel similarity of the first channel and the second channel is greater than a first threshold value based on identifying that the packet loss has occurred in the first channel; and based on identifying that the inter-channel similarity is greater than the first threshold value, restore the signal of the first channel received in the first section by applying sound localization between the first channel and the second channel to the signal of the second channel received in the first section.

### CROSS-REFERENCE TO RELATED APPLICATIONS

This application is a continuation of International Application No. PCT/KR2024/015198 designating the United States, filed on Oct. 7, 2024, in the Korean Ministry of Intellectual Property Receiving Office and claiming priority to Korean Patent Application Nos. 10-2023-0152377, filed on Nov. 7, 2023, and 10-2023-0173490, filed on Dec. 4, 2023, in the Korean Ministry of Intellectual Property, the disclosures of each of which are incorporated by reference herein in their entireties.

### BACKGROUND

### Field

The disclosure relates to an electronic device for providing an audio service and an operating method thereof.

### Description of Related Art

Recently, with the development of information communication technology, various wireless communication technologies and various services have been developed. A Bluetooth scheme which is one of short-range communication schemes has been actively used, and electronic devices using the Bluetooth scheme have been also widely used. A pair of ear buds which may be respectively worn on both ears of a user have been widely used as an ear-wearable device. The ear-wearable device may provide various functions. For example, the ear-wearable device may use a microphone to input and identify a user's voice, transmit audio data related to the user's voice to an electronic device (e.g., a smart phone), and use a speaker to output audio data received from the electronic device.

### SUMMARY

Embodiments of the disclosure may provide an electronic device for providing an audio service and an operating method thereof.

Embodiments of the disclosure may provide an electronic device which restores data received via a communication link in which an RLF occurs if the RLF occurs in at least one of communication links between electronic devices providing an audio service based on data received via another communication link in which the RLF does not occur, and an operating method thereof.

According to an example embodiment of the disclosure, an electronic device is provided, and the electronic device may comprise: communication circuitry, at least one processor including processing circuitry, and memory storing instructions.

According to an example embodiment of the disclosure, the instructions, when executed by at least one processor, individually or in any combination, may cause the electronic device to: receive, in a first period, via the communication circuitry, a signal of a first channel from a first external electronic device, and a signal of a second channel from a second external electronic device.

According to an example embodiment of the disclosure, the instructions, when executed by at least one processor, individually or in any combination, may cause the electronic device to identify that a packet loss occurs in the first channel.

According to an example embodiment of the disclosure, the instructions, when executed by at least one processor, individually or in any combination, may cause the electronic device to, based on identifying that the packet loss occurs in the first channel, identify whether inter-channel similarity for the first channel and the second channel is greater than a first threshold value.

According to an example embodiment of the disclosure, the instructions, when executed by at least one processor, individually or in any combination, may cause the electronic device to, based on identifying that the inter-channel similarity is greater than the first threshold value, restore the signal of the first channel received in the first period by applying a sound location characteristic (e.g., sound localization) between the first channel and the second channel to the signal of the second channel received in the first period.

According to an example embodiment of the disclosure, a method of operating an electronic device is provided, and the method may comprise receiving, in a first period, a signal of a first channel from a first external electronic device, and a signal of a second channel from a second external electronic device.

According to an example embodiment of the disclosure, the method may comprise identifying that a packet loss occurs in the first channel.

According to an example embodiment of the disclosure, the method may comprise, based on identifying that the packet loss occurs in the first channel, identifying whether inter-channel similarity for the first channel and the second channel is greater than a first threshold value.

According to an example embodiment of the disclosure, the method may comprise, based on identifying that the inter-channel similarity is greater than the first threshold value, restoring the signal of the first channel received in the first period by applying a sound location characteristic (e.g., sound localization) between the first channel and the second channel to the signal of the second channel received in the first period.

According to an example embodiment of the disclosure, a non-transitory computer-readable storage medium storing at least one instruction readable by a computer may be provided.

According to an example embodiment of the disclosure, the at least one instruction, when executed by at least one processor, including processing circuitry, of an electronic device, individually or in any combination, may cause the electronic device to perform at least one operation.

According to an example embodiment of the disclosure, the at least one operation may comprise receiving, in a first period, a signal of a first channel from a first external electronic device, and a signal of a second channel from a second external electronic device.

According to an example embodiment of the disclosure, the at least one operation may comprise identifying that a packet loss occurs in the first channel.

According to an example embodiment of the disclosure, the at least one operation may comprise, based on identifying that the packet loss occurs in the first channel, identifying whether inter-channel similarity for the first channel and the second channel is greater than a first threshold value.

According to an example embodiment of the disclosure, the at least one operation may comprise, based on identifying that the inter-channel similarity is greater than the first threshold value, restoring the signal of the first channel received in the first period by applying a sound location characteristic (sound localization) between the first channel and the second channel to the signal of the second channel received in the first period.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device within a network environment according to various example embodiments.

FIG. 2 is a diagram illustrating an example of connections between electronic devices based on a Bluetooth scheme in a wireless communication network according to various example embodiments.

FIG. 3 is a block diagram illustrating an example configuration of a first external electronic device in a wireless communication network according to various example embodiments.

FIG. 4 is a block diagram illustrating an example configuration of an electronic device in a wireless communication network according to various example embodiments.

FIG. 5 is a graph illustrating an ILD according to various example embodiments.

FIG. 6 is a graph illustrating an ITD according to various example embodiments.

FIG. 7 is a graph illustrating a transient signal detection scheme according to various example embodiments.

FIG. 8 is a diagram illustrating an example scheme of restoring an audio signal based on an inter-channel PLC scheme according to various example embodiments.

FIG. 9 is a diagram illustrating an example scheme of restoring an audio signal based on an intra-channel PLC scheme according to various example embodiments.

FIG. 10 is a block diagram illustrating an example configuration of an electronic device and a first external electronic device in a wireless communication network according to various example embodiments.

FIG. 11 is a flowchart illustrating an example method of operating an electronic device in a case that a packet loss occurs, according to various example embodiments.

FIG. 12 is a flowchart illustrating an example method of operating an electronic device according to various example embodiments.

### DETAILED DESCRIPTION

Hereinafter, various example embodiments of the disclosure will be described in greater detail with reference to the accompanying drawings. In the following description, a detailed description of relevant known functions or configurations incorporated herein may be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the disclosure.

It should be noted that the technical terms used herein are used to describe various example embodiments, and are not intended to limit the disclosure. The technical terms used herein should be interpreted to have the same meaning as those commonly understood by a person skilled in the art to which the disclosure pertains, and should not be interpreted have excessively comprehensive or excessively restricted meanings unless particularly defined as other meanings. When the technical terms used herein are wrong technical terms that cannot correctly represent the idea of the disclosure, it should be appreciated that they are replaced by technical terms correctly understood by those skilled in the art. The general terms used in the disclosure should be interpreted as defined in dictionaries or interpreted in the context of the relevant part, and should not be interpreted to have excessively restricted meanings.

A singular expression used herein may include a plural expression unless they are definitely different in the context. As used herein, such an expression as “comprises” or “include”, or the like should not be interpreted to necessarily include all elements or all operations described in the disclosure, and should be interpreted to be allowed to exclude some of them or further include additional elements or operations.

The terms including an ordinal number, such as expressions “a first” and “a second” may be used to describe various elements, but the corresponding elements should not be limited by such terms. These terms are used merely to distinguish between one element and any other element. For example, a first element may be termed a second element, and similarly, a second element may be termed a first element without departing from the scope of the disclosure.

It should be understood that when an element is referred to as being “connected” or “coupled” to another element, it may be connected or coupled directly to the other element, or any other element may be interposed between them. It should be understood that when an element is referred to as being “directly connected” or “directly coupled” to another element, there are no element interposed between them.

Hereinafter, the disclosure will be described in greater detail with reference to the accompanying drawings. Regardless of drawing signs, the same or like elements are provided with the same reference numeral, and a repeated description thereof may be omitted. In describing the disclosure, a detailed description of relevant known technologies may be omitted when it is determined that the description may make the subject matter of the disclosure unclear. It should be noted that the accompanying drawings are presented merely to aid in easy understanding of the disclosure, and should not be construed to limit the disclosure. The disclosure should be construed to cover all changes, equivalents, and alternatives, in addition to the drawings.

Hereinafter, the disclosure will describe an electronic device, but the electronic device may be referred to as a terminal, a mobile station, a mobile equipment (ME), a user equipment (UE), a user terminal (UT), a subscriber station (SS), a wireless device, a handheld device, or an access terminal (AT). In the disclosure, the electronic device may be a device having a communication function such as, for example, a mobile phone, a personal digital assistant (PDA), a smart phone, a wireless MODEM, a notebook, or the like.

In disclosure, a standard specified by Bluetooth special interest group (SIG) is referred to, but the disclosure can be modified and applied to other communication systems having a similar technical background without departing from the scope of the disclosure, and the modifications can be made on the basis of determination of those skilled in the art.

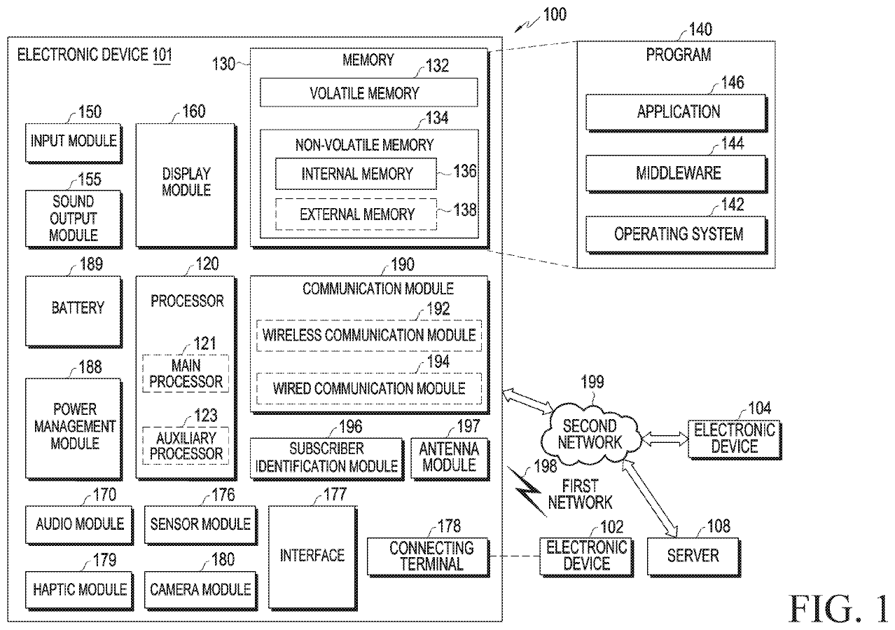

FIG. 1 is a block diagram illustrating an example electronic device 101 in a network environment 100 according to various example embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively (e.g., in any combination) in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence model is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1^{st}” and “2^{nd},” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or two or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

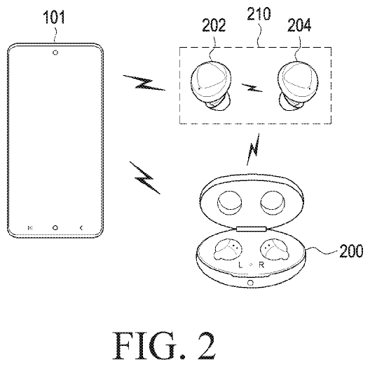

FIG. 2 is a diagram illustrating an example of connections between electronic devices based on a Bluetooth scheme in a wireless communication network according to various example embodiments.

Referring to FIG. 2, an electronic device 101 (e.g., an electronic device 101 in FIG. 1) may be connected wirelessly with an ear-wearable device 210 (e.g., an electronic device 102 in FIG. 1)). In an embodiment, the electronic device 101 may include a smart phone. The ear-wearable device 210 may include a first external electronic device 202 (e.g., a left earbud) and a second external electronic device 204 (e.g., a right earbud).

In an embodiment, it is assumed that the first external electronic device 202 and the second external electronic device 204 are included in the ear-wearable device 210, but the first external electronic device 202 and the second external electronic device 204 may include any electronic device as long as the first external electronic device 202 and the second external electronic device 204 may operate as a pair as well as the ear-wearable device 210. According to an embodiment, the first external electronic device 202 and the second external electronic device 204 may be implemented to include the same or similar components.

According to an embodiment, the electronic device 101 and the first external electronic device 202 and the second external electronic device 204 may establish a connection (e.g., a communication link) with one another and transmit and/or receive data to and from one another. For example, the electronic device 101 and each of the first external electronic device 202 and/or the second external electronic device 204 may establish a communication link based on a near-field communication scheme such as a Wi-Fi scheme and/or a Bluetooth scheme, however, a scheme for establishing the communication link in the electronic device 101 and each of the first external electronic device 202 and the second external electronic device 204 is not limited to at least one of the Wi-Fi scheme and/or the Bluetooth scheme.

In an embodiment, the electronic device 101 may establish a communication link with only one of the first external electronic device 202 and the second external electronic device 204 or may establish a communication link with each of the first external electronic device 202 and the second external electronic device 204.

In an embodiment, the first external electronic device 202 and the second external electronic device 204 may establish a communication link based on at least one of the Wi-Fi scheme and/or the Bluetooth scheme, however, a scheme for establishing the communication link in the first external electronic device 202 and the second external electronic device 204 is not limited to at least one of the Wi-Fi scheme and/or the Bluetooth scheme.

In an embodiment, one of the first external electronic device 202 and the second external electronic device 204 may be a central device (or a primary device or a main device), and the other one may operate as a peripheral device (or a secondary device). A device operating as a central device may transmit data to a device operating as a peripheral device. For example, when the first external electronic device 202 and the second external electronic device 204 establish a communication link with each other, one of the first external electronic device 202 and the second external electronic device 204 may be randomly selected as a central device, and the other one may be selected as a peripheral device.

The first external electronic device 202 and the second external electronic device 204 may communicate directly or indirectly with a third external electronic device 200. In an embodiment, the third external electronic device 200 may be an ear buds case device which stores and charges the first external electronic device 202 and the second external electronic device 204.

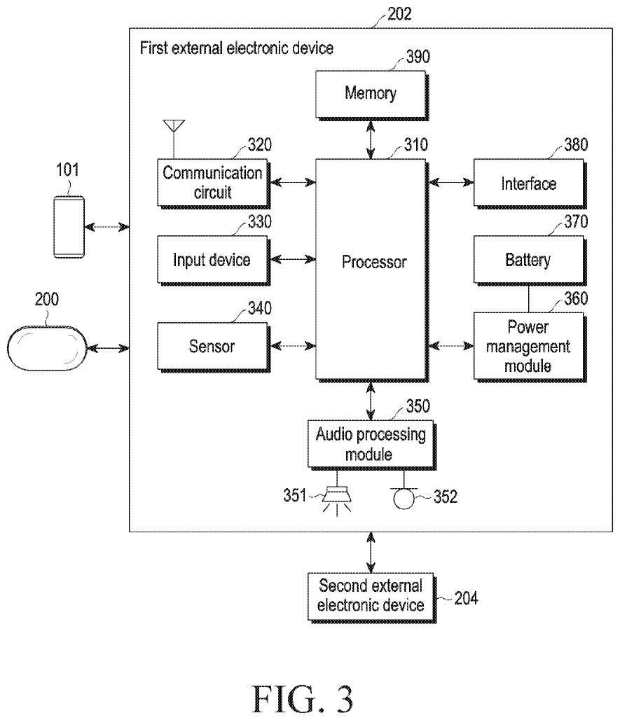

FIG. 3 is a block diagram illustrating an example configuration of a first external electronic device 202 in a wireless communication network according to various example embodiments.

Referring to FIG. 3, an electronic device 101 (e.g., an electronic device 101 in FIG. 1 or FIG. 2) may be connected wirelessly to an ear wearable device (e.g., an electronic device 102 in FIG. 1 or an ear wearable device 210 in FIG. 2). In an embodiment, the electronic device 101 may, for example, be a smart phone, and the ear wearable device may include a first external electronic device 202 (e.g., a first external electronic device 202 in FIG. 2 (e.g., a left earbud) and a second external electronic device 204 (e.g., a second external electronic device 204 in FIG. 2)(e.g., a right earbud).

In FIG. 3, it is described that each of the first external electronic device 202 and the second external electronic device 204 is implemented as an earbud, but the first external electronic device 202 and the second earbud 204 may be implemented as various types of devices (e.g., a smart watch, a head-mounted display device, devices for measuring a biometric signal (e.g., an electrocardiogram patch)) which may include at least one electrode and sensor device to be described below, or the like. According to an embodiment, if each of the first external electronic device 202 and the second external electronic device 204 is implemented as the earbud, the first external electronic device 202 and the second external electronic device 204 may indicate a pair. According to an embodiment, the first external electronic device 202 and the second external electronic device 204 may be implemented to include the same or similar components.

According to an embodiment, the electronic device 101, the first external electronic device 202, and the second external electronic device 204 may establish a connection (e.g., a communication link) with one another and transmit and/or receive data to and from one another. For example, the electronic device 101 and each of the first external electronic device 202 and the second external electronic device 204 may establish a communication link using at least one of a Wi-Fi scheme and/or a Bluetooth scheme, however, a scheme for establishing the communication link in the electronic device 101 and each of the first external electronic device 202 and the second external electronic device 204 is not limited to at least one of the Wi-Fi scheme and/or the Bluetooth scheme.

In an embodiment, the electronic device 101 may connect a communication link to only one (e.g., a central earbud) of the first external electronic device 202 and the second external electronic device 204 or may connect communication links with both of the first external electronic device 202 and the second external electronic device 204.

In an embodiment, the first external electronic device 202 and the second external electronic device 204 may establish a communication link based on at least one of the Wi-Fi scheme and/or the Bluetooth scheme, however, a scheme for establishing the communication link in the first external electronic device 202 and the second external electronic device 204 is not limited to at least one of the Wi-Fi scheme and/or the Bluetooth scheme.

In an embodiment, the first external electronic device 202 may include the substantially same or similar components to at least one of the components (e.g., modules) of the electronic device 101 (e.g., the electronic device 101 in FIG. 1). The first external electronic device 202 may include a communication circuit 320 (e.g., a communication module 190 in FIG. 1), an input device (e.g., including circuitry) 330 (e.g., an input module 150 in FIG. 1), a sensor 340 (e.g., a sensor module 176 in FIG. 1), an audio processing module (e.g., including circuitry and/or executable program instructions) 350 (e.g., an audio module 170 in FIG. 1), a memory 390 (e.g., a memory 130 in FIG. 1), a power management module (e.g., including a power supply) 360 (e.g., a power management module 188 in FIG. 1), a battery 370 (e.g., a battery 189 in FIG. 1), an interface (e.g., including circuitry) 380 (e.g., an interface 177 in FIG. 1), and/or a processor (e.g., including processing circuitry) 310 (e.g., a processor 120 in FIG. 1).

According to an embodiment, the communication circuit 320 may include at least one of a wireless communication module (e.g., a Bluetooth communication module, a cellular communication module, a wireless-fidelity (Wi-Fi) communication module, a near-field communication (NFC) communication module, or a GNSS communication module) or a wired communication module (e.g., a LAN communication module or a power line communication (PLC) communication module).

The communication circuit 320 may directly or indirectly communicate with at least one of the electronic device 101, a third external electronic device 200, or the second external electronic device 204 through a first network (e.g., a first network 198 in FIG. 1), using at least one communication module. The second external electronic device 204 may be a pair with the first external electronic device 202. The communication module 320 may include one or more communication processors which are operable independently from the processor 310 and supports wired or wireless communication.

According to an embodiment, the communication circuit 320 may be connected to one or a plurality of antennas for transmitting signals or information to another device (e.g., the electronic device 101, the second external electronic device 204, or the third external electronic device 200 or receiving signals or information from the other device. According to an embodiment, at least one antenna appropriate for a communication scheme used in a communication network, such as the first network (e.g., the first network 198 of FIG. 1) or the second network (e.g., the second network 199 of FIG. 2), may be selected from the plurality of antennas by the communication circuit 320. The signal or information may then be transmitted or received between the communication circuit 320 and another device via the selected at least one antenna.

According to an embodiment, the input device 330 may include various circuitry and be configured to generate various input signals that may be used for operation of the first external electronic device 202. For example, the input device 330 may include at least one of a touch pad, or a touch panel, or a button.

According to an embodiment, the input device 330 may generate a user input related to the turn-on or turn-off of the first external electronic device 202. According to an embodiment, the input device 330 may receive a user input for establishing a communication link between the first external electronic device 202 and the second external electronic device 204. According to an embodiment, the input device 330 may receive a user input related to audio data (or audio content). For example, the user input may be associated with functions of starting playback of audio data, pausing playback, stopping playback, adjusting playback speed, adjusting playback volume, or muting.

According to an embodiment, the sensor 340 may obtain a location or an operation state of the first external electronic device 202. The sensor 340 may convert an obtained signal into an electric signal. For example, the sensor 340 may include at least one of a magnetic sensor, an acceleration sensor, a gyro sensor, a geomagnetic sensor, a proximity sensor, a gesture sensor, a grip sensor, a biometric sensor, and/or an optical sensor.

According to an embodiment, the processor 310 may include various processing circuitry and obtain data (e.g., audio data) from a data packet (e.g., an audio packet) received from the electronic device 101, and process the obtained data via the audio processing module 350 to output the processed data to the speaker 351. The audio processing module 350 may support an audio data gathering function and reproduce the gathered audio data. The detailed description of the processor 120 above applies equally to the processor 310, and as such a detailed description may not be repeated here.

According to an embodiment, the audio processing module 350 may include an audio decoder (not shown) and a D/A converter (not shown). The audio decoder may convert audio data stored in the memory 390 or received from the electronic device 101 via communication circuit 320 into a digital audio signal. The D/A converter may convert the digital audio signal converted by the audio decoder into an analog audio signal. According to an embodiment, the audio decoder may convert audio data received from the electronic device 101 via the communication circuit 320 and stored in the memory 390 into a digital audio signal. The speaker 351 may output the analog audio signal converted by the D/A converter.

According to an embodiment, the audio processing module 350 may include an A/D converter (not shown). The A/D converter may convert the analog audio signal transferred via a microphone 352 into a digital voice signal. For example, the microphone 352 may include at least one air conduction microphone and/or at least one bone conduction microphone for obtaining voice and/or sound.

According to an embodiment, the audio processing module 350 may play various audio data set in the operation of the first external electronic device 202. For example, the processor 310 may be designed to identify insertion or removal of the first external electronic device 202 into/from the user's ear via the sensor 340 and reproduce audio data regarding an effect sound or guide sound via the audio processing module 350. The output of the sound effect or guide sound may be omitted according to the user setting or the designer's intention.

According to an embodiment, the memory 390 may store various data used by at least one component (e.g., the processor 310 or the sensor 340) of the first external electronic device 202. For example, data may include software and input data or output data for an instruction related thereto. The memory 390 may include a volatile memory or a non-volatile memory.

According to an embodiment, the power management module 360 may include a power supply and manage power supplied to the first external electronic device 202. According to an embodiment, the power management module 360 may be implemented as at least part of a power management integrated circuit (PMIC). According to an embodiment, the power management module 360 may include a battery charging module. According to an embodiment, if another device (e.g., one of the electronic device 101, the second external electronic device 204, and/or the third external electronic device 200) is electrically (wirelessly or wiredly) connected to the first external electronic device 202, the power management module 360 may receive power from the other electronic device to charge the battery 370.

According to an embodiment, the battery 370 may supply power to at least one component of the first external electronic device 202. According to an embodiment, the battery 370 may include a rechargeable battery. According to an embodiment, if the first external electronic device 202 is mounted in the third external electronic device 206, the first external electronic device 202 may charge the battery 370 to a designated charge level and then power on the first external electronic device 202 or turn on at least part of the communication circuit 320.

According to an embodiment, the interface 380 may include various circuitry and support one or more designated protocols which may be used for the first external electronic device 202 to directly (e.g., wiredly) connect to the electronic device 101, the third external electronic device 200, the second external electronic device 204, or the other electronic device. According to an embodiment, the interface 380 may include a high definition multimedia interface (HDMI), a USB interface, an SD card interface, a power line communication (PLC) interface, or an audio interface. According to an embodiment, the interface 380 may include at least one connection port for establishing a physical connection with the third external electronic device 200.

According to an embodiment, the processor 310 may execute software to control at least one other component (e.g., a hardware or software component) of the first external electronic device 202 connected with the processor 310 and may process or compute various data. According to an embodiment, as at least part of the data processing or computation, the processor 310 may load an instruction or data received from another component (e.g., the sensor 340 or communication circuit 320) onto a volatile memory 390, process the instruction or the data stored in the volatile memory 390, and store resulting data in a non-volatile memory.

According to an embodiment, the processor 310 may establish a communication link with the electronic device 101 via the communication circuit 320 and receive data (e.g., audio data) from the electronic device 101 through the established communication link. According to an embodiment, the processor 310 may transmit the data, received from the electronic device 101 via the communication circuit 320, to the second external electronic device 204. According to an embodiment, the processor 310 may perform operations of the first external electronic device 202 which are to be described below.

According to an embodiment, the first external electronic device 202 may further include various modules depending on the form in which it is provided. There are many variations according to the convergence trend of digital devices, so it is not possible to list them all, but components equivalent to the above-mentioned components may be further included in the first external electronic device 202. It will be apparent that in the first external electronic device 202 according to an embodiment, specific components may be excluded from the components described in FIG. 3 or the specific components may be replaced with other components according to the form in which it is provided.

According to an embodiment, the second external electronic device 204 configured in pair with the first external electronic device 202 may include the same or similar components to those included in the first external electronic device 202 and may perform all or some of an operation of the second external electronic device 204 to be described in greater detail below.

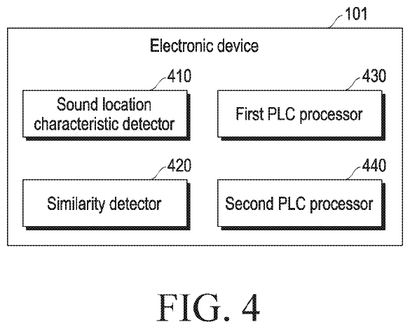

FIG. 4 is a block diagram illustrating an example configuration of an electronic device 101 in a wireless communication network according to various example embodiments.

Referring to FIG. 4, an electronic device 101 (e.g., an electronic device 101 in FIG. 1, 2, or 3) may be a device which implements a BLE scheme. In an embodiment, the electronic device 101 may operate as a source device.

According to an embodiment, an electronic device 101 may include a sound location characteristic (sound localization) detector 410, a similarity detector 420, a first packet loss concealment (PLC) processor 430, and/or a second PLC processor 440, each of which may include various circuitry and/or executable program instructions.

In FIG. 4, a case that the sound location characteristic detector 410, the similarity detector 420, the first PLC processor 430, and/or the second PLC processor 440 are implemented as separate blocks will be described as an example, but some of the sound location characteristic detector 410, the similarity detector 420, the first PLC processor 430, and/or the second PLC processor 440 may be integrated. For example, the sound location characteristic detector 410, the similarity detector 420, the first PLC processor 430, and/or the second PLC processor 440 may be implemented as at least one processor (e.g., a processor 120 in FIG. 1).

The Bluetooth scheme may include a Bluetooth legacy scheme or a Bluetooth low energy (BLE) scheme. Each of external electronic devices (e.g., a first external electronic device (e.g., a left earbud) and a second external electronic device (e.g., a right earbud) which provide an audio over BLE (AoBLE) service based on the BLE scheme may establish a communication link independently of the electronic device (e.g., a smartphone), and transmit and receive data to and from the electronic device via the established communication link.

If the first external electronic device, the second external electronic device, and the electronic device connected based on the BLE scheme provide a stereo audio service such as a music play, each of the first external electronic device and the second external electronic device may operate as a sink device, and the electronic device may operate as a source device. The first external electronic device may perform a first audio channel (e.g., a left audio channel) role, and the second electronic device may perform a second audio channel (e.g., a light audio channel) role. Each of the first external electronic device and the second external electronic device may transmit a device capability identifier (ID) (e.g., a connected isochronous stream (CIS) ID) related to an audio channel role performed by each of the first external electronic device and the second external electronic device to the electronic device at a set time point. For example, the set time point may be a time point at which each of the first external electronic device and the second external electronic device is connected to the electronic device, or a time point at which a service (e.g., the stereo audio service) starts. The electronic device may identify an audio channel role performed by each of the first external electronic device and the second external electronic device based on the device capability ID received from each of the first external electronic device and the second external electronic device, and may transmit and receive audio data to and from each of the first external electronic device and the second external electronic device based on the identified audio channel role.

The AoBLE service may include various services such as a multi-channel audio service, a binaural recording service, and/or a stereo call service, and if the first external electronic device, the second external electronic device, and the electronic device connected based on the BLE scheme provide the binaural recording service, each of the first external electronic device and the second external electronic device may transmit audio data inputted via a microphone of each of the first external electronic device and the second external electronic device to an external electronic device.

Since each of the first external electronic device and the second external electronic device transmits and receives the audio data to and from the electronic device via the communication link established based on the BLE scheme, if a packet loss occurs in a communication link of any one of the first external electronic device and the second external electronic device while providing the binaural recording service, service quality degradation may occur such as distortion occurs, or a roaring sound or silence occurs on one side of a sound source recorded in a stereo type.

There is a need for a scheme which enables the electronic device to stably provide the audio service even if the packet loss occurs in the communication link of any one of the first external electronic device and the second external electronic device.

According to an embodiment, a plurality of sound sources recorded with stereo have a common audio characteristic, and a stereoscopic sound may be implemented by reflecting a location characteristic of the plurality of sound sources. So, if it is possible to obtain a sound location characteristic which is a location characteristic of a channel (e.g., an audio channel), it may be possible to predict a signal (e.g., an audio signal) of a second channel among a plurality of channels by reflecting a location characteristic of a first channel among the plurality of channels.

The disclosure provides a scheme of restoring, based on a location characteristic of a channel, an audio signal of a channel on which a packet loss occurs by reflecting a sound location characteristic in a signal of a channel which is normally received (for example, on which the packet loss does not occur) if the packet loss occurs on only one of a plurality of channels.

In an embodiment, a location characteristic (e.g., a sound location characteristic) of a sound source may include an interaural level difference (ILD) and/or an interaural time difference (ITD). The ILD may represent a difference between levels (or intensities) of sound sources reaching both ears, and the ITD may represent a difference between times of the sound sources reaching the both ears. In FIG. 4, it will be assumed that the plurality of audio channels include two audio channels including a left channel and a right channel.

The structure of the electronic device 101 illustrated in FIG. 4 may be a structure in a case that an audio signal is transmitted from a wearable device (e.g., an electronic device 102 in FIG. 1 or an ear wearable device 210 in FIG. 2) to the electronic device 101. In this case, the structure of the electronic device 101 illustrated in FIG. 4 may be applied, for example, during binaural recording and a stereo call. In an embodiment, the wearable device may include a first external electronic device (e.g., a first external electronic device 202 in FIG. 2 or 3) (e.g., a left earbud) and a second external electronic device (e.g., a second external electronic device 204 in FIG. 2 or 3) (e.g., a right earbud).

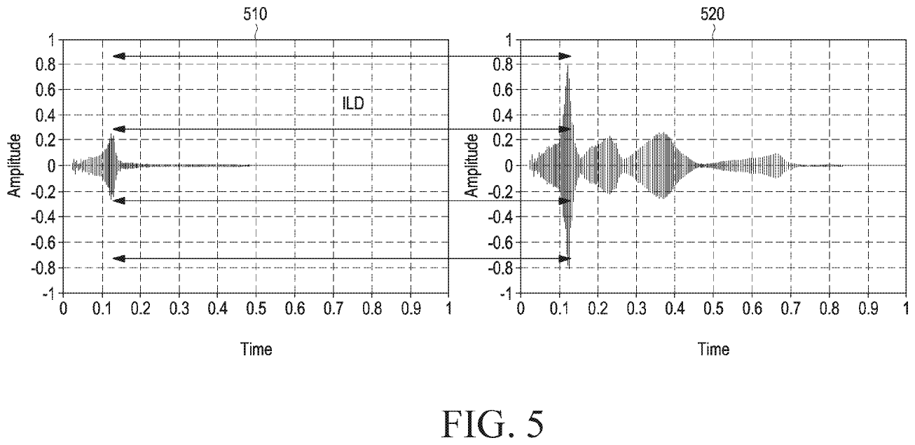

In an embodiment, the sound location characteristic detector 410 may detect a sound location characteristic from a received left channel and right channel. In an embodiment, the sound location characteristic may include at least one of an ILD value between the left channel and the right channel and/or an ITD value between the left channel and the right channel. In an embodiment, the ILD value between the left channel and the right channel may represent a difference between a level of an audio signal of the left channel and a level of an audio signal of the right channel, as shown in FIG. 5.

FIG. 5 is a diagram including graphs illustrating an ILD according to various example embodiments.

Referring to FIG. 5, a graph 510 may represent a signal (e.g., an audio signal) of a first channel (e.g., a left channel), and a graph 520 may represent a signal (e.g., an audio signal) of a second channel (e.g., a right channel). An ILD may represent a difference between levels of a sound (or intensities of sound pressure) of both ears. Sound from the right has a higher level at a right ear than at a left ear because a head shadows the left ear. These level differences may vary significantly depending on a frequency, and as the frequency increases, the level differences may also increase. For example, when an audio signal is generated in a horizontal plane, an angle relative to the head may be an azimuth, an azimuth of 0° may be directly in front of a listener listening to the audio signal, an azimuth of 90° may be to the right of the listener, and an azimuth of 180° may be directly behind the listener. Graphs 510 and 520 for describing the ILD illustrated in FIG. 5 may be graphs when assuming that a sound source is a sweep from the azimuth of 90° (e.g., from the right).

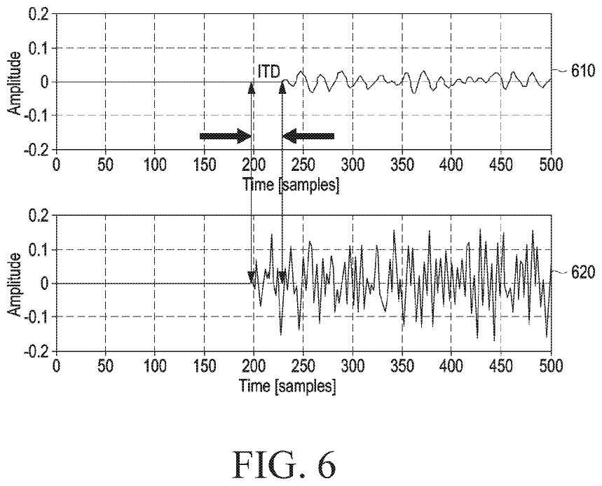

In an embodiment, an ITD value between the left channel and the right channel may represent a difference between arrival time of an audio signal of the left channel and arrival time of an audio signal of the right channel, as shown in FIG. 6.

FIG. 6 is a diagram including graphs illustrating an ITD according to various example embodiments.

Referring to FIG. 6, a graph 610 may represent a signal (e.g., an audio signal) of a second channel (e.g., a right channel), and a graph 620 may represent a signal (e.g., an audio signal) of a first channel (e.g., a left channel). An ITD may represent a difference in arrival times of sounds at both ears. If an audio signal arrives at the head from one side, the signal may need to travel further to reach the far ear than the near ear. This path length difference may result in a difference between sound arrivals at both ears, and such a difference between the sound arrivals may be used for identifying a direction of a sound source. For example, when an audio signal is generated in a horizontal plane, an angle relative to the head may be an azimuth, an azimuth of 0° may be directly in front of a listener listening to the audio signal, an azimuth of 90° may be to the right of the listener, and an azimuth of 180° may be directly behind the listener. Graphs 610 and 620 for describing the ITD illustrated in FIG. 6 may be graphs when assuming that a sound source is a white noise of 100 ms from the azimuth of 90° (e.g., from the right).

In an embodiment, the similarity detector 420 may detect inter-channel similarity and/or intra-channel similarity. The similarity detector 420 may detect inter-channel similarity between a plurality of channels (e.g., a first channel and a second channel). In an embodiment, similarity between channels may be detected based on correlation between the channels. In an embodiment, the similarity between the channels may be detected based on an ITD value. For example, when the ITD value between the channels is less than or equal to a set threshold ITD value, it may be determined that the similarity between the channels is high. In an embodiment, the similarity between the channels may be detected based on an ILD value. For example, if the ILD value between the channels is less than or equal to a set threshold ILD value, it may be determined that the similarity between the channels is high.

In an embodiment, if the similarity detected in the similarity detector 420 is high, the first PLC processor 430 may restore an audio signal of a channel on which a packet loss is detected based on an audio signal of a channel on which a packet is normally received (for example, on which the packet loss is not detected) and inter-channel location information (e.g., a sound location characteristic). In an embodiment, if the similarity detected in the similarity detector 420 is low, the second PLC processor 440 may restore a lost audio signal based on an audio signal received in a period before a corresponding period on the channel on which the packet loss is detected.

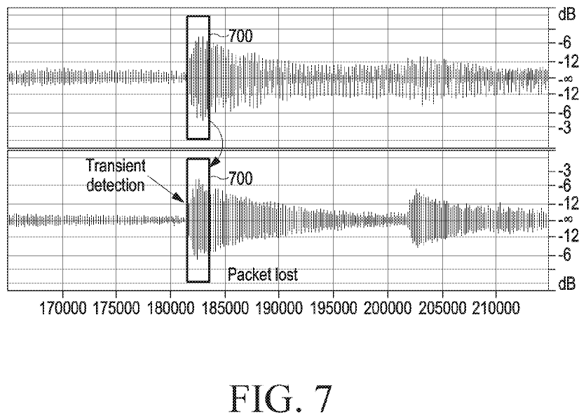

In an embodiment, the intra-channel similarity may include similarity between an audio signal (e.g., an audio frame) received in a first period of a channel and an audio signal received in at least one period before the first period of the channel. In an embodiment, the intra-channel similarity may be detected based on an automatic correlation scheme and/or a transient signal detection (transient detection) scheme. As illustrated in FIG. 7, the transient signal detection scheme may detect the intra-channel similarity based on a transient signal.

FIG. 7 is a diagram including graphs illustrating an example transient signal detection scheme according to various example embodiments.

Referring to FIG. 7, a transient signal period 700 may represent a period in which an amplitude of a signal is rapidly changed. For example, a transient signal period may represent a period in which an amount of change in an amplitude of a signal exceeds a set threshold value. If a packet loss is detected in the transient signal period 700, in the same channel, a characteristic of an audio signal received in the transient signal period 700 may be different from a characteristic of an audio signal received in a period before the corresponding period.

In an embodiment, the similarity detector 420 may detect that intra-channel similarity is low if a transient signal period is detected in a channel, and if the intra-channel similarity detected in the similarity detector 420 is low, the first PLC processor 430 may restore an audio signal of a channel on which a packet loss is detected based on an audio signal of a channel on which a packet is normally received (for example, on which no packet loss is detected) and inter-channel location information (e.g., a sound location characteristic).

If the intra-channel similarity detected in the similarity detector 420 is low, if a lost audio signal is restored based on an audio signal received in a period before a corresponding period on a channel on which a packet loss is detected, a recovery performance may be not good, so the first PLC processor 430 may restore the audio signal of the channel on which the packet loss is detected based on the audio signal of the channel on which the packet is normally received and the inter-channel location information.

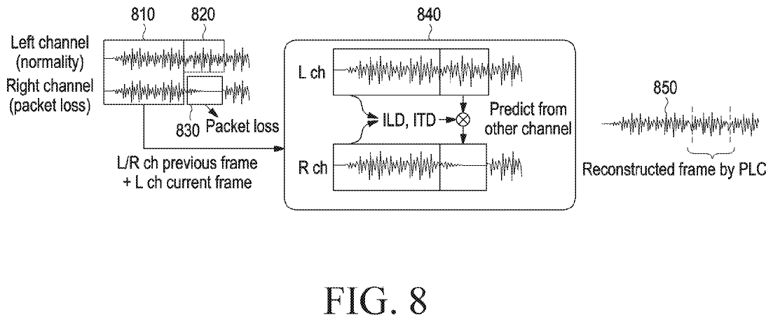

In an embodiment, if the inter-channel similarity detected in the similarity detector 420 is greater than a threshold value (for example, if the inter-channel similarity is high), the first PLC processor 430 may restore the audio signal of the channel on which the packet loss is detected based on the audio signal of the channel which is normally received (for example, on which the packet loss is not detected). In an embodiment, the first PLC processor 430 may be a PLC processor based on an inter-channel PLC scheme, and the first PLC processor 430 may restore an audio signal based on the inter-channel PLC scheme, as illustrated in FIG. 8.

FIG. 8 is a diagram illustrating an example scheme of restoring an audio signal based on an inter-channel PLC scheme according to various example embodiments.

Referring to FIG. 8, if inter-channel similarity detected in a similarity detector 420 is greater than a threshold value (for example, if inter-channel similarity is high), channel characteristics of a plurality of channels (e.g., a first channel and a second channel) may be similar, so a first PLC processor (e.g., a first PLC processor 430 in FIG. 4) may restore an audio signal lost on a channel on which a packet loss is detected by reflecting a sound location characteristic in an audio signal received on a channel on which is normally received (for example, on which the packet loss is not detected). In an embodiment, the sound location characteristic may include an ILD value and/or an ITD value.

As illustrated in FIG. 8, if an audio signal is normally received via both a left channel and a right channel in a first period 810, and a packet loss 830 is detected on the right channel in a second period 820, the first PLC processor may restore (850) an audio signal of the right channel lost in a third period 830 by applying (840) an ILD value and an ITD value between the left channel and the right channel to an audio signal normally received in the second period 820.

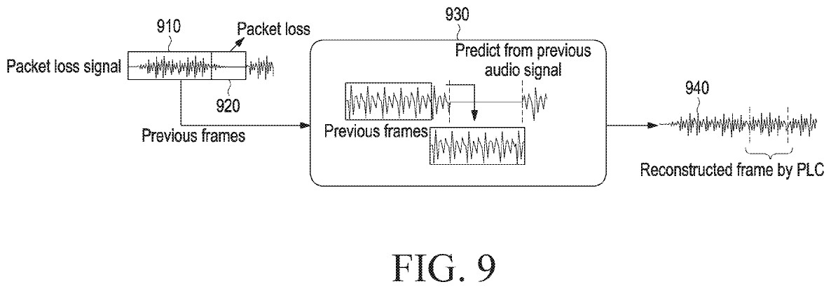

In an embodiment, if the inter-channel similarity detected in the similarity detector 420 is less than or equal to the threshold value (for example, if the inter-channel similarity is low), a second PLC processor 440 may determine that it may be difficult to restore the audio signal of the channel on which the packet loss is detected based on the audio signal of the channel which is normally received (for example, on which the packet loss is not detected), so the second PLC processor 440 may restore the audio signal of the channel on which the packet loss is detected based on a signal received in a period before a corresponding period of the same channel. In an embodiment, the second PLC processor 440 may be a PLC processor based on an intra-channel PLC scheme, and the second PLC processor 440 may restore an audio signal based on the intra-channel PLC scheme, as illustrated an described in greater detail below with reference to FIG. 9.

FIG. 9 is a diagram illustrating an example scheme of restoring an audio signal based on an intra-channel PLC scheme according to various example embodiments.

Referring to FIG. 9, if inter-channel similarity detected in a similarity detector 420 is less than or equal to a first threshold value (for example, if the inter-channel similarity is low), channel characteristics of a plurality of channels (e.g., a first channel and a second channel) may not be similar, so a second PLC processor (e.g., a second PLC processor 440 in FIG. 4) may restore an audio signal lost in a corresponding period based on an audio signal received in a period before the corresponding period of a channel on which a packet loss is detected.

As illustrated in FIG. 9, if an audio signal is normally received on a channel in a first period 910, and a packet loss is detected in a second period 920, the second PLC processor may restore (940) an audio signal of a channel lost in the second period 920 by applying (930) an audio signal normally received in the first period 910 before the second period 920 in which the packet loss is detected.

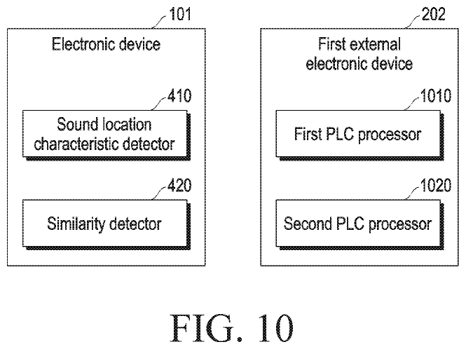

FIG. 10 is a block diagram illustrating an example configuration of an electronic device 101 and a first external electronic device 202 in a wireless communication network according to various example embodiments.

Referring to FIG. 10, an electronic device 101 (e.g., an electronic device 101 in FIG. 1, 2, 3, or 4) may be a device which implements a BLE scheme. In an embodiment, the electronic device 101 may operate as a source device. A first external electronic device 202 (e.g., a first external electronic device 202 in FIG. 2 or 3) may be a device which implements the BLE scheme. In an embodiment, the first external electronic device 202 may operate as a sink device.

For example, the electronic device 101 may include a sound location characteristic detector 410 (e.g., a sound location characteristic detector 410 in FIG. 4) and/or a similarity detector 420 (e.g., a similarity detector 420 in FIG. 4), each of which may include various circuitry and/or executable program instructions.

For example, the first external electronic device 202 may include a first PLC processor 1010 and/or a second PLC processor 1020, each of which may include various circuitry and/or executable program instructions.

In FIG. 10, a case in which the sound location characteristic detector 410 and/or the similarity detector 420 are implemented as separate blocks will be described as an example, but the sound location characteristic detector 410 and the similarity detector 420 may be integrated, and the sound location characteristic detector 410 and the similarity detector 420 may be implemented as at least one processor (e.g., a processor 120 in FIG. 1).

In FIG. 10, a case in which the first PLC processor 1010 and/or the second PLC processor 1020 are implemented as separate blocks will be described as an example, but the first PLC processor 1010 and/or the second PLC processor 1020 may be integrated, and the first PLC processor 1010 and/or the second PLC processor 1020 may be implemented as at least one processor (e.g., a processor 310 in FIG. 3).

For example, a plurality of sound sources recorded by stereo may have a common audio characteristic, and a stereoscopic sound may be implemented by reflecting a location characteristic of the plurality of sound sources. So, if it is possible to obtain a sound location which is a location characteristic of an audio channel, it may be possible to predict an audio signal of a second audio channel among a plurality of audio channels by reflecting a location characteristic of a first audio channel among the plurality of audio channels. Various embodiments of the disclosure provide a scheme of restoring, based on a location characteristic of an audio channel, an audio signal of an audio channel on which a packet loss occurs by reflecting a location characteristic of a sound source of the audio channel on which the packet loss occurs in a signal of an audio channel which is normally received (for example, on which the packet loss does not occur) if the packet loss occurs on only one of a plurality of audio channels. In an embodiment, a location characteristic of a sound source may include an ILD and/or an ITD. In FIG. 10, it will be assumed that the plurality of audio channels include two audio channels including a left channel and a right channel.

A structure of the electronic device 101 and the first external electronic device 202 illustrated in FIG. 10 may be a structure in a case that an audio signal is transmitted from a wearable device (e.g., an electronic device 102 in FIG. 1 or an ear wearable device 210 in FIG. 2) to the electronic device 101. In this case, the structure of the electronic device 101 and the first external electronic device 202 illustrated in FIG. 10 may be applied, for example, during binaural recording and a stereo call. In an embodiment, the ear wearable device may include the first external electronic device 202 (e.g., a left earbud) and a second external electronic device (e.g., a second external electronic device 204 in FIG. 2 or 3) (e.g., a right earbud), the structure of the first external electronic device 202 is illustrated in FIG. 10, for example, and a structure of the second external electronic device 204 may also be implemented in a manner similar to or substantially the same as the structure of the first external electronic device 202.

The sound location characteristic detector 410 and the similarity detector 420 may be implemented to be similar to or substantially the same as those described in FIG. 4, so a detailed description thereof may not be repeated here.

The first PLC processor 1010 and the second PLC processor 1020 may be implemented to be similar to or substantially the same as a first PLC processor 430 and a second PLC processor 440 described in FIG. 4, so a detailed description thereof may not be repeated here. However, in order for the first PLC processor 1010 and the second PLC processor 1020 to operate, it may be required to know inter-channel similarity or intra-channel similarity. Accordingly, the electronic device 101 may transmit information related to inter-channel similarity and/or intra-channel similarity detected in the similarity detector 420 to the first external electronic device 202, and may cause the first external electronic device 202 to restore an audio signal of a channel on which a packet loss is detected using the first PLC processor 1010 or the second PLC processor 1020 based on the information related to the inter-channel similarity and/or the intra-channel similarity received from the electronic device 101.

According to an embodiment, the first external electronic device 202 may also include a sound location characteristic detector and a similarity detector. In this case, the electronic device 101 may not need to separately transmit the inter-channel similarity and/or intra-channel similarity to the first external electronic device 202.

According to an example embodiment of the disclosure, an electronic device (101) (e.g., an electronic device (101) in FIG. 1, 2, 3, 4, or 10) may comprise communication circuitry (190) (e.g., a communication module 190 in FIG. 1), one or more processors (120) (e.g., a processor 120 in FIG. 1) including processing circuitry, and memory (130) (e.g., memory (130) in FIG. 1) storing instructions.

In an example embodiment, a processor may include circuitry such as a CPU, an MPU, an AP, a CP, a System On Chip (SoC), an Integrated Circuit (IC), and/or the like. In an embodiment, the processor may be hardware, software, or anything capable of performing operations and functions claimed in the claims.

According to an embodiment of the disclosure, the instructions, when executed by the one or more processors (120) individually or collectively (e.g., in any combination), may cause the electronic device (101) to receive, in a first period, via the communication circuitry (190), a signal of a first channel from a first external electronic device (202) (e.g., a first external electronic device (202) in FIG. 2, 3, 4, or 10), and a signal of a second channel from a second external electronic device (204) (e.g., a second external electronic device (204) in FIG. 2 or 3).

According to an example embodiment of the disclosure, the instructions, when executed by the one or more processors (120) individually or collectively, may cause the electronic device (101) to identify that a packet loss occurs in the first channel.

According to an example embodiment of the disclosure, the instructions, when executed by the one or more processors (120) individually or collectively, may cause the electronic device (101) to, based on identifying that the packet loss occurs in the first channel, identify whether inter-channel similarity for the first channel and the second channel is greater than a first threshold value.

According to an example embodiment of the disclosure, the instructions, when executed by the one or more processors (120) individually or collectively, may cause the electronic device (101) to, based on identifying that the inter-channel similarity is greater than the first threshold value, restore the signal of the first channel received in the first period by applying a sound location characteristic (sound localization) between the first channel and the second channel to the signal of the second channel received in the first period.

According to an example embodiment of the disclosure, the instructions, when executed by the one or more processors (120) individually or collectively, may cause the electronic device (101) to, based on identifying that the inter-channel similarity is less than or equal to the first threshold value, identify whether intra-channel similarity of the first channel is greater than a second threshold value.

According to an example embodiment of the disclosure, the instructions, when executed by the one or more processors (120) individually or collectively, may cause the electronic device (101) to, based on identifying that the intra-channel similarity of the first channel is less than or equal to the second threshold value, restore the signal of the first channel received in the first period, based on a signal of the first channel received in a second period immediately before the first period among at least one period before the first period.

According to an example embodiment of the disclosure, the instructions, when executed by the one or more processors (120) individually or collectively, may cause the electronic device (101) to, based on identifying that the inter-channel similarity is less than or equal to the first threshold value, identify whether intra-channel similarity of the first channel is greater than a second threshold value.

According to an example embodiment of the disclosure, the instructions, when executed by the one or more processors (120) individually or collectively, may cause the electronic device (101) to, based on identifying that the intra-channel similarity of the first channel is greater than the second threshold value, restore the signal of the first channel received in the first period, based on a signal of the first channel received in at least one period before the first period.

According to an example embodiment of the disclosure, the instructions, when executed by the one or more processors (120) individually or collectively, may cause the electronic device (101) to receive, in at least one period before the first period, via the communication circuitry, a signal of the first channel from the first external electronic device (202), and a signal of the second channel from the second external electronic device (204).

According to an example embodiment of the disclosure, the instructions, when executed by the one or more processors (120) individually or collectively, may cause the electronic device (101) to detect the sound location characteristic, based on the signal of the first channel and the signal of the second channel which are received in the at least one period.

According to an example embodiment of the disclosure, the instructions, when executed by the one or more processors (120) individually or collectively, may cause the electronic device (101) to detect at least one of the inter-channel similarity or the intra-channel similarity of the first channel, based on the signal of the first channel and the signal of the second channel which are received in the at least one period.

According to an example embodiment of the disclosure, the instructions, when executed by the one or more processors (120) individually or collectively, may cause the electronic device (101) to, based on identifying that the inter-channel similarity is less than or equal to the first threshold value, identify whether the intra-channel similarity of the first channel is greater than a second threshold value.

According to an example embodiment of the disclosure, the instructions, when executed by the one or more processors (120) individually or collectively, may cause the electronic device (101) to, based on identifying that the intra-channel similarity of the first channel is less than or equal to the second threshold value, restore the signal of the first channel received in the first period, based on a signal of the first channel received in a second period immediately before the first period among at the least one period.

According to an example embodiment of the disclosure, the sound location characteristic may include at least one of an interaural level difference (ILD) or an interaural time difference (ITD).

According to an example embodiment of the disclosure, the inter-channel similarity may be determined based on at least one of a value of the ILD or a value of the ITD.

According to an example embodiment of the disclosure, the intra-channel similarity of the first channel may be determined based on whether the signal of the first channel received in the at least one period includes a transient period.

According to an example embodiment of the disclosure, the transient period may be a period in which a change amount of the signal of the first channel received in the at least one period is greater than a third threshold value.

According to an example embodiment of the disclosure, the sound location characteristic may include at least one of an interaural level difference (ILD) or an interaural time difference (ITD).

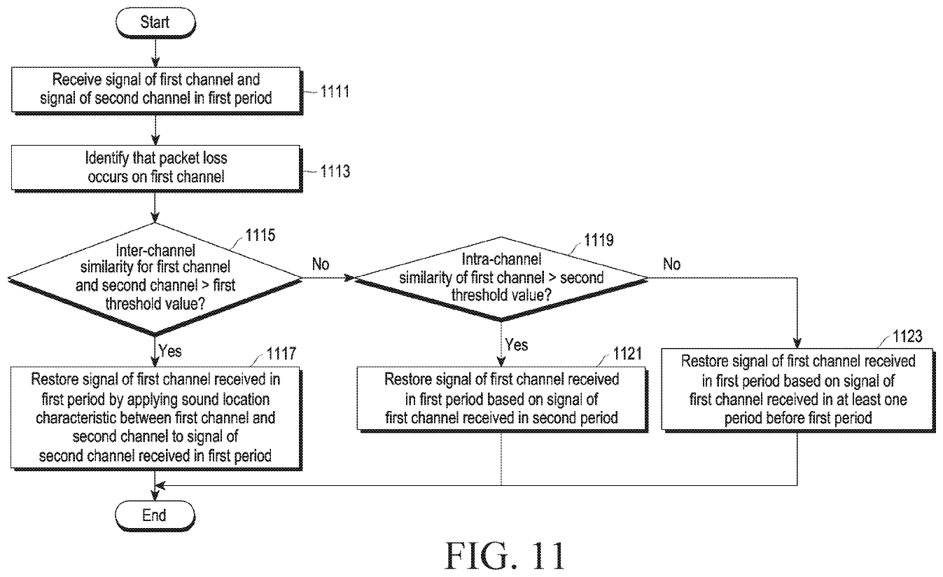

FIG. 11 is a flowchart illustrating an example method of operating an electronic device in a case that a packet loss occurs, according to various example embodiments.

Referring to FIG. 11, an electronic device (e.g., electronic device 101 in FIG. 1, 2, 3, 4, or 10) (e.g., a processor 120 in FIG. 1) may receive a signal of a first channel (e.g., a right channel) from a first external electronic device (e.g., a first external electronic device 202 in FIG. 2, 3, 4, or 10) via at least one communication circuit (e.g., a communication module 190 in FIG. 1) in a first period in operation 1111, and may receive a signal of a second channel (e.g., a right channel) from a second external electronic device (e.g., a second external electronic device 204 in FIG. 2 or 3).

The electronic device which receives the signal of the first channel in the first period and receives the signal of the second channel may, in operation 1113, identify that a packet loss occurs in the first channel.

The electronic device which identifies that the packet loss occurs in the first channel may identify whether inter-channel similarity for the first channel and the second channel is greater than a first threshold value in operation 1115. In an embodiment, the inter-channel similarity may be determined based on at least one of a value of an ILD and a value of an ITD. In an embodiment, the inter-channel similarity may be implemented to be similar to or substantially the same as that described in FIG. 4, so a detailed description thereof may not be repeated here.

If the inter-channel similarity for the first channel and the second channel is greater than the first threshold value (Operation 1115—Yes), the electronic device may, in operation 1117, restore a signal of the first channel received in the first period by applying a sound location characteristic between the first channel and the second channel to a signal of the second channel received in the first period. In an embodiment, the sound location characteristic may include at least one of an ILD or an ITD.

If the inter-channel similarity for the first channel and the second channel is less than or equal to the first threshold value (Operation 1115—No), the electronic device may, in operation 1119, identify whether intra-channel similarity of the first channel is greater than a second threshold value. In an embodiment, the intra-channel similarity of the first channel may be determined based on whether the signal of the first channel received in the at least one period includes a transient signal period. In an embodiment, the transient signal period may be a period in which an amount of change of a signal of the first channel, which is received in at least one period, is greater than a third threshold value.

If the intra-channel similarity of the first channel is greater than the second threshold value (Operation 1119—Yes), the electronic device may, in operation 1121, restore a signal of the first channel received in the first period based on a signal of the first channel received in a second period of at least one period before the first period.

If the intra-channel similarity of the first channel is less than or equal to the second threshold value (Operation 1119—No), the electronic device may, in operation 1123, restore the signal of the first channel received in the first period based on a signal of the first channel received in at least one period before the first period.

For example, the period used for recovery in operation 1123 may be a period before the second period used for recovery in operation 1121.

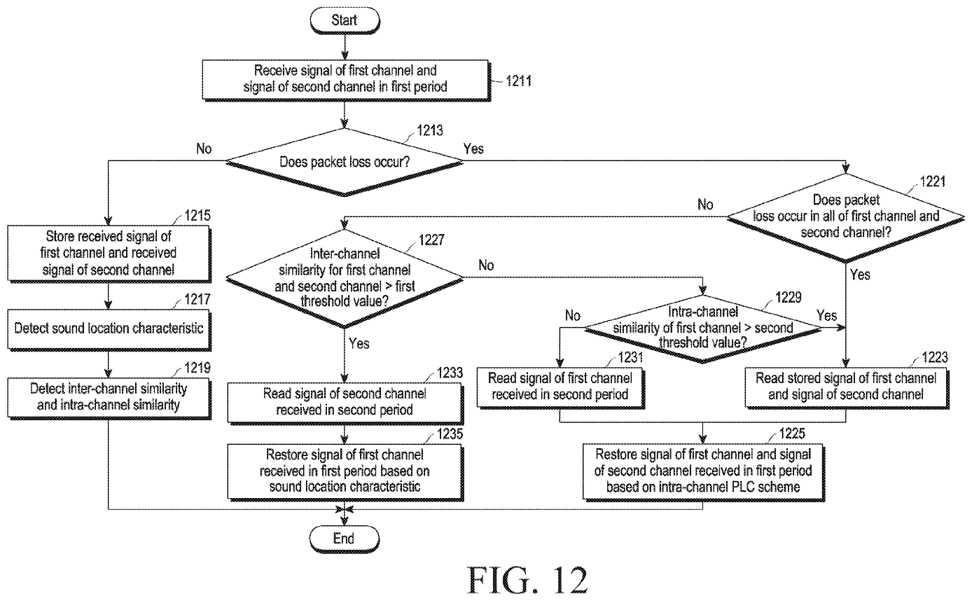

FIG. 12 is a flowchart illustrating an example method of operating an electronic device according to various example embodiments.

Referring to FIG. 12, in operation 1211, an electronic device (e.g., an electronic device 101 in FIG. 1, 2, 3, 4, or 10) (e.g., a processor 120 in FIG. 1) may receive a signal of a first channel (e.g., a right channel) from a first external electronic device (e.g., a first external electronic device 202 in FIG. 2, 3, 4, or 10) via at least one communication circuit (e.g., a communication module 190 in FIG. 1) in a first period and may receive a signal of a second channel (e.g., a right channel) from a second external electronic device (e.g., a second external electronic device 204 in FIG. 2 or 3).

The electronic device which receives the signal of the first channel and the signal of the second channel in the first period, may, in operation 1213, identify whether a packet loss occurs. If the packet loss does not occur (Operation 1213—No), the electronic device may store the received signal of the first channel and the received signal of the second channel at a buffer in operation 1215. The electronic device which stores the received signal of the first channel and the received signal of the second channel may detect a sound location characteristic in operation 1217. In an embodiment, the sound location characteristic may include an ILD value between the first channel (e.g., a left channel) and the second channel (e.g., a right channel) and/or an ITD value between the first channel and the second channel. An operation of detecting the sound location characteristic may be implemented to be similar to or substantially the same as that described in FIG. 4, so a detailed description thereof may not be repeated here.

The electronic device which detects the sound location characteristic may, in operation 1219, detect inter-channel similarity and intra-channel similarity. In an embodiment, the intra-channel similarity may include intra-channel similarity for the first channel and/or intra-channel similarity for the second channel. An operation of detecting the inter-channel similarity and the intra-channel similarity may be implemented to be similar to substantially the same as that described in FIG. 4, so a detailed description thereof may not be repeated here.

As a result of identifying in operation 1213, if the packet loss occurs (Operation 1213—Yes), the electronic device may identify whether the packet loss occurs in all of the first channel and the second channel in operation 1221. If the packet loss occurs in all of the first channel and the second channel (Operation 1221—Yes), the electronic device may read the signal of the first channel and the signal of the second channel, which are stored at the buffer, in operation 1223. That the packet loss occurs in all of the first channel and the second channel may indicate that it may be difficult to use an inter-channel PLC scheme, so the electronic device may determine to apply an intra-channel PLC scheme. Therefore, the electronic device may determine to restore the signal of the first channel and the signal of the second channel by applying the intra-channel PLC scheme to each of the signal of the first channel and the signal of the second channel stored at the buffer.

The electronic device which reads the signal of the first channel and the signal of the second channel stored at the buffer may restore a signal of the first channel and a signal of the second channel received in the first period based on the intra-channel PLC scheme in operation 1225. An operation of restoring the signal of the first channel and the signal of the second channel based on the intra-channel PLC scheme may be implemented to be similar to or substantially the same as that described in FIGS. 4 and 9, so a detailed description thereof may not be repeated here.

If the packet loss does not occur in all of the first channel and the second channel (for example, if the packet loss occurs in one of the first channel and the second channel) (Operation 1221—No), the electronic device may identify whether inter-channel similarity for the first channel and the second channel is greater than a first threshold value in operation 1227. In FIG. 12, it will be assumed that the packet loss occurs in the first channel. That the inter-channel similarity is greater than the set first threshold value may indicate that the inter-channel similarity is high. That the inter-channel similarity is less than or equal to the first threshold value may indicate that the inter-channel similarity is low.

If the inter-channel similarity is less than or equal to the first threshold value (Operation 1227—No), the electronic device may, in operation 1229, identify whether the intra-channel similarity of the first channel is greater than a second threshold value. That the intra-channel similarity of the first channel is greater than the second threshold value may indicate that the intra-channel similarity of the first channel is high. That the intra-channel similarity of the first channel is less than or equal to the second threshold value may indicate that the intra-channel similarity of the first channel is low.

If the intra-channel similarity of the first channel is greater than the second threshold value (Operation 1229—Yes), the electronic device may perform operations 1223 and 1225 to restore the signal of the first channel on which the packet loss occurs.

If the intra-channel similarity of the first channel is less than or equal to the second threshold value (Operation—No), the electronic device may, in operation 1231, read the signal of the first channel received in the second period immediately before the first period and stored at the buffer. For example, if the intra-channel similarity of the first channel is less than or equal to the second threshold value, the intra-channel similarity of the first channel is low, this indicates that a difference between signals of the first channel received in periods before the first period and the signal of the first channel received in the first period is large, so the electronic device may read only the signal of the first channel received in the second period immediately before the first period rather than reading all of the signals of the first channel received in the periods before the first period and stored at the buffer to determine to apply the intra-channel PLC scheme to the read signal of the first channel.

The electronic device which reads the signal of the first channel received in the second period immediately before the first period from the buffer may perform operation 1225 to restore the signal of the first channel on which the packet loss occurs.

If the inter-channel similarity is greater than the first threshold value (Operation 1227—Yes), the electronic device may read the signal of the second channel received in the first period in operation 1233. The electronic device which reads the signal of the second channel received in the first period may, in operation 1235, restore the signal of the first channel on which the packet loss occurs and which is received in the first period by applying the inter-channel PLC scheme to the signal of the second channel received in the first period based on the sound location characteristic. An operation of restoring the signal of the first channel received in the first period by applying the inter-channel PLC scheme to the signal of the second channel received in the first period based on the sound location characteristic may be implemented to be similar to or substantially the same as that described in FIGS. 4 and 8, so a detailed description thereof may not be repeated here.

According to an example embodiment of the disclosure, a method of operating an electronic device (101) may comprise receiving, in a first period, a signal of a first channel from a first external electronic device (202), and a signal of a second channel from a second external electronic device (204).

According to an example embodiment of the disclosure, the method may comprise identifying that a packet loss occurs in the first channel.

According to an example embodiment of the disclosure, the method may comprise, based on identifying that the packet loss occurs in the first channel, identifying whether inter-channel similarity for the first channel and the second channel is greater than a first threshold value.

According to an example embodiment of the disclosure, the method may comprise, based on identifying that the inter-channel similarity is greater than the first threshold value, restoring the signal of the first channel received in the first period by applying a sound location characteristic (sound localization) between the first channel and the second channel to the signal of the second channel received in the first period.

According to an example embodiment of the disclosure, the method may comprise, based on identifying that the inter-channel similarity is less than or equal to the first threshold value, identifying whether intra-channel similarity of the first channel is greater than a second threshold value.

According to an example embodiment of the disclosure, the method may comprise, based on identifying that the intra-channel similarity of the first channel is less than or equal to the second threshold value, restoring the signal of the first channel received in the first period, based on a signal of the first channel received in a second period immediately before the first period among at least one period before the first period.

According to an example embodiment of the disclosure, the method may comprise, based on identifying that the inter-channel similarity is less than or equal to the first threshold value, identifying whether intra-channel similarity of the first channel is greater than a second threshold value.

According to an example embodiment of the disclosure, the method may comprise, based on identifying that the intra-channel similarity of the first channel is greater than the second threshold value, restoring the signal of the first channel received in the first period, based on a signal of the first channel received in at least one period before the first period.

According to an example embodiment of the disclosure, the method may comprise receiving, in at least one period before the first period, a signal of the first channel from the first external electronic device, and a signal of the second channel from the second external electronic device.

According to an example embodiment of the disclosure, the method may comprise detecting the sound location characteristic, based on the signal of the first channel and the signal of the second channel which are received in the at least one period.

According to an example embodiment of the disclosure, the method may comprise detecting at least one of the inter-channel similarity or the intra-channel similarity of the first channel, based on the signal of the first channel and the signal of the second channel which are received in the at least one period.

According to an example embodiment of the disclosure, the method may comprise, based on identifying that the inter-channel similarity is less than or equal to the first threshold value, identifying whether the intra-channel similarity of the first channel is greater than a second threshold value.

According to an example embodiment of the disclosure, the method may comprise, based on identifying that the intra-channel similarity of the first channel is less than or equal to the second threshold value, restoring the signal of the first channel received in the first period, based on a signal of the first channel received in a second period immediately before the first period among at the least one period.

According to an example embodiment of the disclosure, the sound location characteristic may include at least one of an interaural level difference (ILD) or an interaural time difference (ITD).

According to an example embodiment of the disclosure, the inter-channel similarity may be determined based on at least one of a value of the ILD or a value of the ITD.

According to an example embodiment of the disclosure, the intra-channel similarity of the first channel may be determined based on whether the signal of the first channel received in the at least one period includes a transient period.

According to an example embodiment of the disclosure, the transient period may be a period in which a change amount of the signal of the first channel received in the at least one period is greater than a third threshold value.

According to an example embodiment of the disclosure, the sound location characteristic may include at least one of an interaural level difference (ILD) or an interaural time difference (ITD).

According to an example embodiment of the disclosure, a non-transitory computer-readable storage medium storing at least one instruction readable by a computer may be provided.

According to an example embodiment of the disclosure, the at least one instruction, when executed by one or more processors (120) including processing circuitry, may cause an electronic device (101) to perform at least one operation.

According to an example embodiment of the disclosure, the at least one operation may comprise receiving, in a first period, a signal of a first channel from a first external electronic device (202), and a signal of a second channel from a second external electronic device (204).

According to an example embodiment of the disclosure, the at least one operation may comprise identifying that a packet loss occurs in the first channel.

According to an example embodiment of the disclosure, the at least one operation may comprise, based on identifying that the packet loss occurs in the first channel, identifying whether inter-channel similarity for the first channel and the second channel is greater than a first threshold value.

According to an example embodiment of the disclosure, the at least one operation may comprise, based on identifying that the inter-channel similarity is greater than the first threshold value, restoring the signal of the first channel received in the first period by applying a sound location characteristic (sound localization) between the first channel and the second channel to the signal of the second channel received in the first period.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device, comprising:
communication circuitry;
at least one processor comprising processing circuitry; and
memory storing instructions that, when executed by at least one processor, individually or in any combination, cause the electronic device to:
receive, in a first period, via the communication circuitry, a signal of a first channel from a first external electronic device, and a signal of a second channel from a second external electronic device,
identify that a packet loss occurs in the first channel,
based on identifying that the packet loss occurs in the first channel, identify whether inter-channel similarity for the first channel and the second channel is greater than a first threshold value, and
based on identifying that the inter-channel similarity is greater than the first threshold value, restore the signal of the first channel received in the first period by applying a sound location characteristic between the first channel and the second channel to the signal of the second channel received in the first period.

2. The electronic device of claim 1, wherein the instructions, when executed by at least one processor, individually or in any combination, cause the electronic device to:
based on identifying that the inter-channel similarity is less than or equal to the first threshold value, identify whether intra-channel similarity of the first channel is greater than a second threshold value, and
based on identifying that the intra-channel similarity of the first channel is less than or equal to the second threshold value, restore the signal of the first channel received in the first period, based on a signal of the first channel received in a second period immediately before the first period among at least one period before the first period.

3. The electronic device of claim 1, wherein the instructions, when executed by at least one processor, individually or in any combination, cause the electronic device to:
based on identifying that the inter-channel similarity is less than or equal to the first threshold value, identify whether intra-channel similarity of the first channel is greater than a second threshold value, and
based on identifying that the intra-channel similarity of the first channel is greater than the second threshold value, restore the signal of the first channel received in the first period, based on a signal of the first channel received in at least one period before the first period.

4. The electronic device of claim 1, wherein the instructions, when executed by at least one processor, individually or in any combination, cause the electronic device to:
receive, in at least one period before the first period, via the communication circuitry, a signal of the first channel from the first external electronic device, and a signal of the second channel from the second external electronic device, and
detect the sound location characteristic, based on the signal of the first channel and the signal of the second channel received in the at least one period.

5. The electronic device of claim 4, wherein the instructions, when executed by at least one processor, individually or in any combination, cause the electronic device to:
detect at least one of the inter-channel similarity and/or the intra-channel similarity of the first channel, based on the signal of the first channel and the signal of the second channel received in the at least one period

6. The electronic device of claim 4, wherein the instructions, when executed by at least one processor, individually or in any combination, cause the electronic device to:
based on identifying that the inter-channel similarity is less than or equal to the first threshold value, identify whether the intra-channel similarity of the first channel is greater than a second threshold value, and
based on identifying that the intra-channel similarity of the first channel is less than or equal to the second threshold value, restore the signal of the first channel received in the first period, based on a signal of the first channel received in a second period immediately before the first period among at the least one period.

7. The electronic device of claim 1, wherein the sound location characteristic includes at least one of an interaural level difference (ILD) and/or an interaural time difference (ITD).

8. The electronic device of claim 7, wherein the inter-channel similarity is determined based on at least one of a value of the ILD and/or a value of the ITD.

9. The electronic device of claim 2, wherein the intra-channel similarity of the first channel is determined based on whether the signal of the first channel received in the at least one period includes a transient period, and
wherein the transient period includes a period in which a change amount of the signal of the first channel received in the at least one period is greater than a third threshold value.

10. The electronic device of claim 9, wherein the sound location characteristic includes at least one of an interaural level difference (ILD) and/or an interaural time difference (ITD).

11. A method of operating an electronic device, the method comprising:
receiving, in a first period, a signal of a first channel from a first external electronic device, and a signal of a second channel from a second external electronic device;
identifying that a packet loss occurs in the first channel;
based on identifying that the packet loss occurs in the first channel, identifying whether inter-channel similarity for the first channel and the second channel is greater than a first threshold value; and
based on identifying that the inter-channel similarity is greater than the first threshold value, restoring the signal of the first channel received in the first period by applying a sound location characteristic between the first channel and the second channel to the signal of the second channel received in the first period.

12. The method of claim 11, further comprising:
based on identifying that the inter-channel similarity is less than or equal to the first threshold value, identifying whether intra-channel similarity of the first channel is greater than a second threshold value; and
based on identifying that the intra-channel similarity of the first channel is less than or equal to the second threshold value, restoring the signal of the first channel received in the first period, based on a signal of the first channel received in a second period immediately before the first period among at least one period before the first period.

13. The method of claim 11, further comprising:
based on identifying that the inter-channel similarity is less than or equal to the first threshold value, identifying whether intra-channel similarity of the first channel is greater than a second threshold value; and
based on identifying that the intra-channel similarity of the first channel is greater than the second threshold value, restoring the signal of the first channel received in the first period, based on a signal of the first channel received in at least one period before the first period.

14. The method of claim 11, further comprising:
receiving, in at least one period before the first period, a signal of the first channel from the first external electronic device, and a signal of the second channel from the second external electronic device; and
detecting the sound location characteristic, based on the signal of the first channel and the signal of the second channel received in the at least one period.

15. A non-transitory computer-readable storage medium storing at least one instruction, wherein the at least one instruction, when executed by at least one processor, including processing circuitry, of an electronic device, individually or in any combination, causes the electronic device to perform at least one operation, comprising:
receiving, in a first period, a signal of a first channel from a first external electronic device, and a signal of a second channel from a second external electronic device;
identifying that a packet loss occurs in the first channel;
based on identifying that the packet loss occurs in the first channel, identifying whether inter-channel similarity for the first channel and the second channel is greater than a first threshold value; and
based on identifying that the inter-channel similarity is greater than the first threshold value, restoring the signal of the first channel received in the first period by applying a sound location characteristic between the first channel and the second channel to the signal of the second channel received in the first period.

16. The method of claim 14, comprising:
detecting at least one of the inter-channel similarity and/or the intra-channel similarity of the first channel, based on the signal of the first channel and the signal of the second channel received in the at least one period 17. The method of claim 14, comprising:
based on identifying that the inter-channel similarity is less than or equal to the first threshold value, identifying whether the intra-channel similarity of the first channel is greater than a second threshold value; and
based on identifying that the intra-channel similarity of the first channel is less than or equal to the second threshold value, restoring the signal of the first channel received in the first period, based on a signal of the first channel received in a second period immediately before the first period among at the least one period.

18. The method of claim 11, wherein the sound location characteristic includes at least one of an interaural level difference (ILD) and/or an interaural time difference (ITD).

19. The method of claim 17, wherein the inter-channel similarity is determined based on at least one of a value of the ILD and/or a value of the ITD.

20. The method of claim 12, wherein the intra-channel similarity of the first channel is determined based on whether the signal of the first channel received in the at least one period includes a transient period, and
wherein the transient period includes a period in which a change amount of the signal of the first channel received in the at least one period is greater than a third threshold value.
